(19) United States
(12) Patent Application Publication
(10) Pub. No.: US 2009/0156056 A1
(43) Pub. Date: Jun. 18, 2009

(54) DEVICE FOR REMOVING FOREIGN SUBSTANCES FROM USB PORT FOR VEHICLES

(75) Inventor: Sung Woo Park, Seoul (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/326,364

(22) Filed: Dec. 2, 2008

(30) Foreign Application Priority Data
Dec. 18, 2007 (KR) 10-2007-0133100

(51) Int. Cl. H01R 33/945

(52) U.S. Cl. 439/577

(57) ABSTRACT

A device for removing foreign substances from a USB port for vehicles includes a removal plate, a toothed rod, a gear assembly, a reversible rotation motor, and a control unit. The removal plate is installed to a lower end in the USB port in such a way as to be movable up and down. The toothed rod is mounted to a bottom portion of the removal plate so as to be able to move the removal plate up and down, with teeth being provided on a surface of the toothed rod. The gear assembly engages with the teeth for moving the toothed rod up and down. The reversible rotation motor rotates the gear assembly in two opposite directions. The control unit controls the operation of the motor. The device allows users to remove foreign substances in a simpler way.

### CROSS-REFERENCE TO RELATED APPLICATIONS

This application claims under 35 U.S.C. §119(a) priority to Korean Application No. 10-2007-0133100, filed on Dec. 18, 2007, the disclosure of which is incorporated herein by reference in its entirety.

### BACKGROUND

1. Technical Field

The present invention relates to a device for removing foreign substances from a USB port for vehicles.

2. Background Art

Some vehicles are provided with a USB port which connects an external (USB) device to an A/V device and serves as a data transmission medium for transmitting data stored in the USB device to the A/V device. The data stored in the USB device are transferred through the USB port, and are played using an audio or video device.

As shown in FIG. 1, a conventional USB port 1 and an AUX port 2 are provided on a multimedia terminal 3. A lid 4 is provided on the multimedia terminal 3 in such a way as to pivot around one end of the lid 4, thus preventing foreign substances from entering the USB port 1 or AUX port 2.

In the state in which the lid 4 is not closed, when the USB port 1 is horizontally mounted to the multimedia terminal 3, as shown in FIG. 1, there is not much possibility of foreign substances entering the USB port 1. However, if the USB port 1 is vertically mounted, there is strong possibility of foreign substances entering the USB port 1. In this case, the USB device may not be inserted into the USB port 1. Even if the USB device is inserted into the USB port 1, the data stored in the USB device may not be precisely transferred to the A/V device.

Particularly, a lot of small-sized foreign substances are present in a console box of a vehicle which is provided with the multimedia terminal 3, so that the foreign substances frequently enter the USB port 1.

Once the foreign substances enters the USB port 1, it is difficult for a user to remove the foreign substances from the USB port 1 using his or her finger because the space in which the foreign substances are present is too small. Further, although the foreign substances can be taken out from the USB port 1 using a tool, a terminal provided in the USB port 1 may be damaged. Further, although the multimedia terminal 3 can be separated from the vehicle and shaken to remove the foreign substances, it is cumbersome.

The above information disclosed in this the Background section is only for enhancement of understanding of the background of the invention and therefore it may contain information that does not form the prior art that is already known in this country to a person of ordinary skill in the art.

### SUMMARY OF DISCLOSURE

Accordingly, the present invention has been made keeping in mind the above problems occurring in the prior art, and an object of the present invention is to provide a device for removing foreign substances from a USB port for vehicles in a simpler manner.

In order to accomplish the above object, one aspect of the present invention provides a device for removing foreign substances from a USB port for vehicles, including a removal plate, a toothed rod, a gear assembly, a reversible rotation motor, and a control unit. The removal plate is installed to a lower end in the USB port in such a way as to be movable up and down. The toothed rod is mounted to a bottom portion of the removal plate so as to be able to move the removal plate up and down, with teeth being provided on a surface of the toothed rod. The gear assembly engages with the teeth for moving the toothed rod up and down. The reversible rotation motor rotates the gear assembly in two opposite directions. The control unit controls the operation of the motor.

Preferably, a signal indicating inflow of foreign substances may be input from a key(input unit) of an audio device to the control unit.

Preferably, the toothed rod may further include a guide unit to guide the vertical movement of the toothed rod.

Preferably, the guide unit may include a guide line which limits the vertical movement of the toothed rod to a predetermined distance, a guide screw which is installed at the guide line and is moved with the toothed rod, and a guide sensor which is installed at each of upper and lower ends of the guide line and transmits a signal for stopping the motor to the control unit when the guide sensor comes into contact with the guide screw.

Preferably, the gear assembly may include a first gear which is rotated by rotating force transmitted from the motor, and a second gear which engages with the first gear and rotates along with the first gear, thus moving the toothed rod up and down.

Preferably, the control unit may move the removal plate downwards so that the removal plate automatically returns to an original position thereof in a preset time (e.g., 3 seconds) after the foreign substances are removed from the USB port.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing the state in which a conventional USB port for vehicles is mounted;

FIG. 2 is a schematic view showing a device for removing foreign substances from a USB port for vehicles according to an embodiment of the present invention;

FIG. 3 is a plan view showing the interior of the USB port of FIG. 2;

FIG. 4 is a schematic view showing a device for removing foreign substances from a USB port for vehicles according to another embodiment of the present invention;

FIG. 5 is a schematic view showing the operation of the foreign-substance removing device of FIG. 4; and

FIG. 6 is a flowchart illustrating the operation of a device for removing foreign substances from a USB port for vehicles according to an embodiment of the present invention.

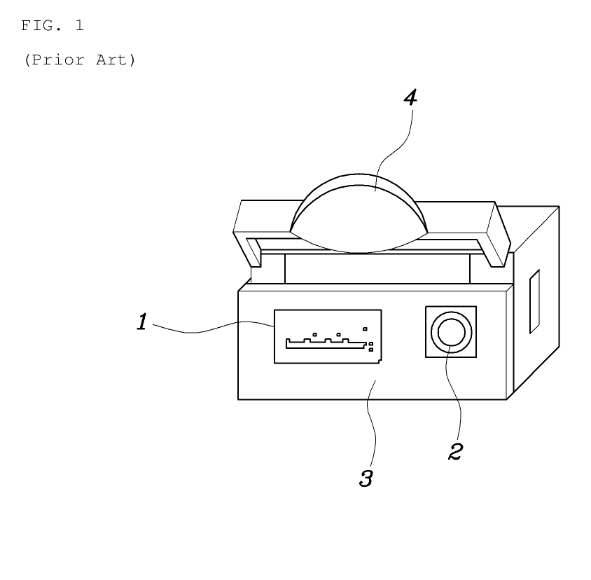

### DETAILED DESCRIPTION

Hereinafter, devices for removing foreign substances from a USB port for vehicles, according to preferred embodiments of the present invention, will be described with reference to the accompanying drawings.

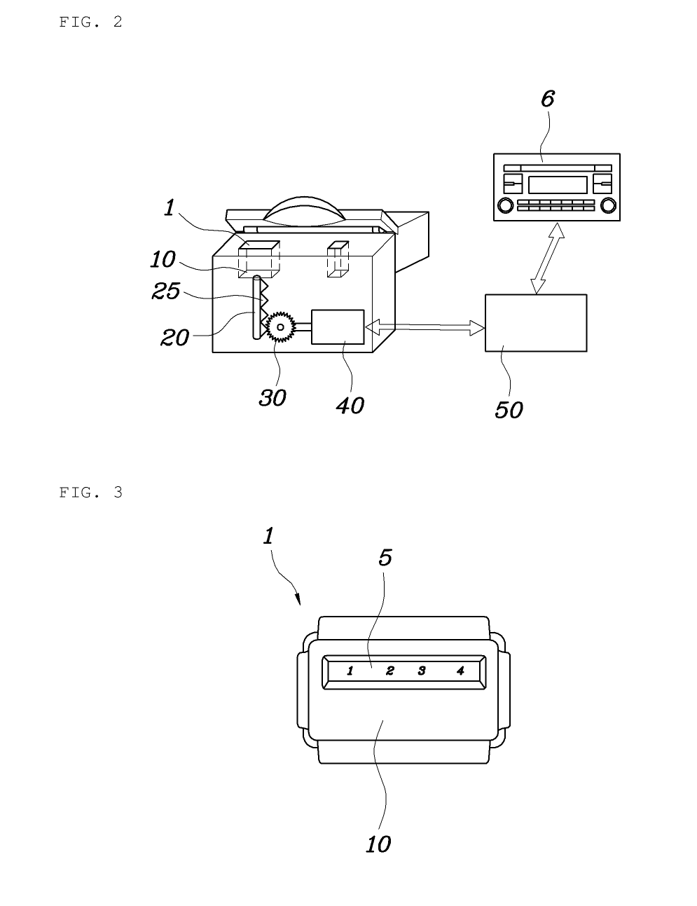

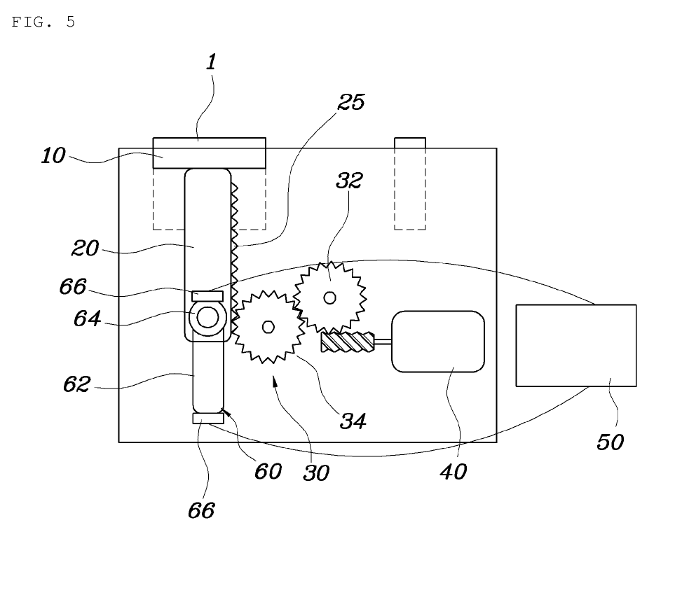

As shown in FIG. 2, a device for removing foreign substances from a USB port 1 for vehicles, according to a preferred embodiment of the present invention, includes a removal plate 10, a toothed rod 20, a gear assembly 30, a motor 40, and a control unit 50. In a modified embodiment, as shown in FIG. 4, the device may further include a guide unit 60.

The removal plate 10 is installed on at least a portion of the lower end of the USB port 1 in such a way as to be movable upward and downward. The foreign substances which has entered the USB port 1 are placed on at least a portion of the upper surface of the removal plate 10.

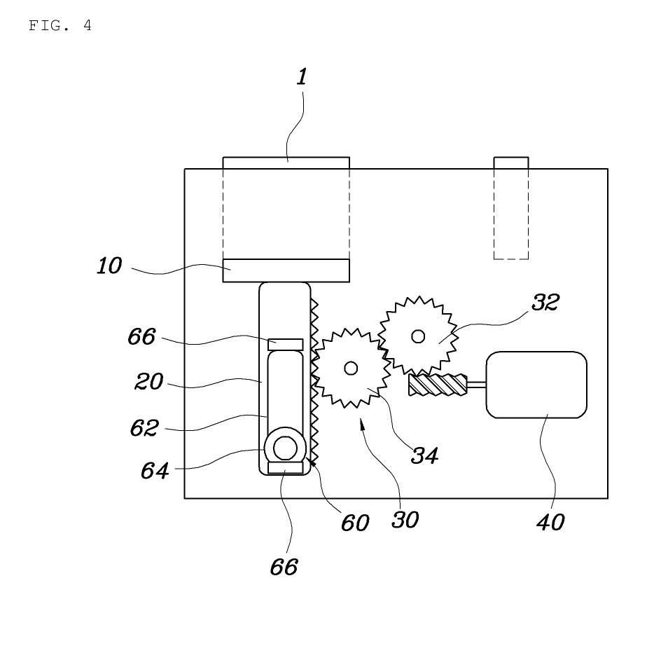

As shown in FIG. 3, the removal plate 10 is installed under a terminal 5 to allow a USB device to be easily connected to the USB terminal 5.

The toothed rod 20 is mounted to a portion of the bottom of the removal plate 10, and functions to move the removal plate 10 up and down by the rotating force transmitted from the motor 40. Further, teeth 25 are provided on one surface of the toothed rod 20, and engage with the gear assembly 30 to move the toothed rod 20 up and down according as the motor 40 rotates.

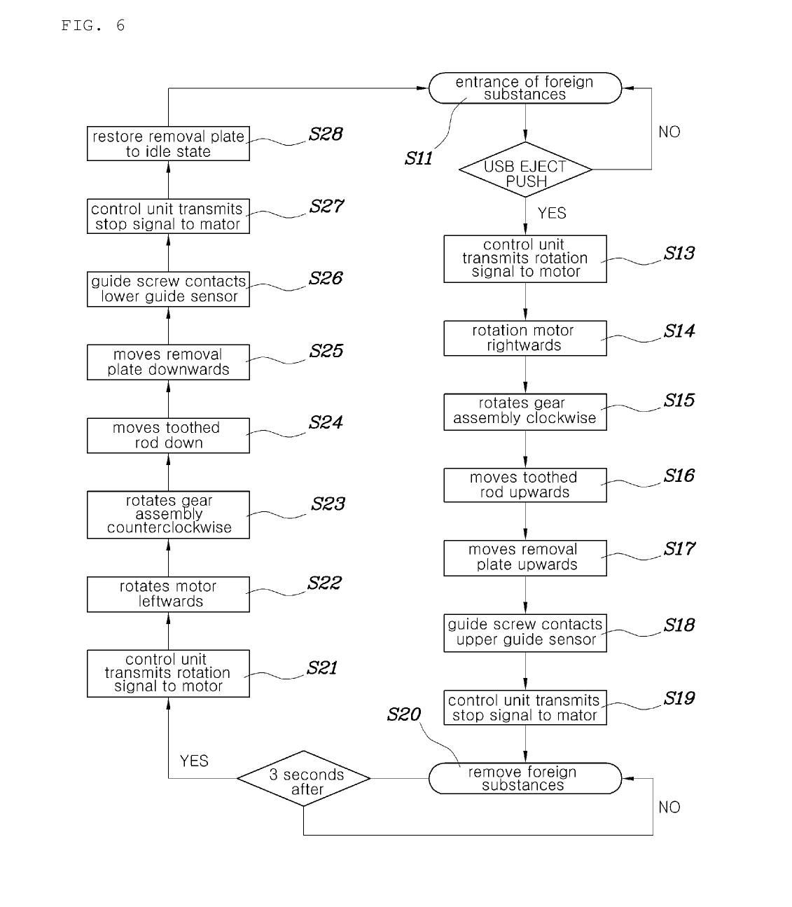

As described above, in a modified embodiment, the guide unit 60 may be further provided on the toothed rod 20 so as to guide the vertical movement of the toothed rod 20, as shown in FIGS. 4 and 5.

The guide unit 60 includes a guide line 62, a guide screw 64, and guide sensors 66. The guide line 62 functions to limit the vertical movement of the toothed rod 20 to a predetermined distance. The guide screw 64 fastens the toothed rod 20 to the guide line 62 and is moved with the toothed rod 20. The guide sensors 66 are installed at the upper and lower ends of the guide line 62. When each guide sensor 66 comes into contact with the guide screw 64, the guide sensor 66 transmits a signal to the control unit 50 to stop the motor 40.

The teeth 25 may be provided on the entire tooth rod 20 or only on a portion of the toothed rod 20 that engages with the gear assembly 30.

The gear assembly 30 engaged with the teeth 25 is rotated by the motor 40, thus moving the toothed rod 20 up and down.

Further, in another modified embodiment, the gear assembly 30 may include a first gear 32, which is rotated by the rotating force transmitted from the motor 40, and a second gear 34, which engages with the first gear 32 and rotates along with the first gear 32, thus moving the toothed rod 20 up and down, as shown in FIGS. 4 and 5.

The motor 40 comprises a reversible rotation motor to rotate the gear assembly 30 in opposite directions, and is controlled by the control unit 50. That is, the motor 40 is coupled to the control unit 50, and is operated under the control of the control unit 50, into which a signal is input from a key of an audio device 6. Thus, the vertical movement of the toothed rod 20 is performed by the first and second gears 32 and 34, which engage with each other, and the motor 40 driving the first and second gears 32 and 34.

As described above, the control unit 50 serves to control the operation of the motor 40. That is, when a signal indicating the inflow of foreign substances is input from the key of the audio device 6 to the control unit 50, the motor 40 is operated. Here, the control unit 50 can lower the removal plate 10 so that it automatically returns to its original position in a predetermined time (e.g., 3 seconds) after the foreign substances are removed.

The operation of the above-described device for removing foreign substances from the USB port 1 for vehicles will be described below with reference to the flowchart of FIG. 6.

First, a user checks whether foreign substances enter the USB port 1 or not, at step S11.

When it is determined that the foreign substances enter the USB port 1, the USB device is removed from the USB port 1, at step S12.

Next, when a command that the foreign substances be removed is input through the key of the audio device 6 to the control unit 50, the control unit 50 transmits a rotation signal to the motor 40, at step S13.

When the rotation signal is input from the control unit 50, the motor 40 is rotated, at step S14.

As the motor 40 rotates, the gear assembly 30 is rotated, at step S15.

As the gear assembly 30 rotates, the toothed rod 20 is moved up by the teeth 25, which are engaged with the gear assembly 30, at step S16.

When the toothed rod 20 moves up, the removal plate 10, having on the upper surface thereof the foreign substances, is moved upwards, at step S17.

After the upward movement of the removal plate 10 has been completed, the guide screw 64 of the guide unit 60 moves along the guide line 62, and comes into contact with the guide sensor 66, which is provided on the upper end of the guide line 62, at step S18.

Further, when the guide screw 64 comes into contact with the guide sensor 66, the signal, indicating the contact of the guide screw 64 with the guide sensor 66, is sent to the control unit 50 so that the motor 40 is stopped, at step S19.

Thereby, the removal plate 10 is stopped at the surface of the USB port 1, and the user has only to remove the foreign substances from the removal plate 10, at step S20.

3 seconds after the foreign substances are removed from the USB port 1, the following returning operation is automatically conducted.

3 seconds after the foreign substances are removed from the upper surface of the removal plate 10, the control unit 50 transmits a rotation signal to the motor 40, at step S21.

The motor 40, which receives the rotation signal from the control unit 50, is rotated opposite to a direction in which the motor 40 moved to make the tooth rod 20 move upwards, at step S22.

As the motor 40 rotates, the gear assembly 30 is rotated opposite to a direction in which the gear assembly 30 moved to make the tooth rod 20 move upwards at step S23.

By the gear assembly 30 rotating, the toothed rod 20 is moved downwards at step S24.

As the toothed rod 20 is moved downwards, the removal plate 10 is also moved downwards at step S25.

When the downward movement of the removal plate 10 has been completed, the guide screw 64 of the guide unit 60 moves along the guide line 62, and comes into contact with the guide sensor 66, which is provided on the lower end of the guide line 62, at step S26.

Further, when the guide screw 64 comes into contact with the guide sensor 66, which is provided on the lower end of the guide line 62, the contact signal is sent to the control unit 50, so that the motor 40 stops rotating, at step S27.

Finally, the removal plate 10 is restored to an idle state at step S28.

As described above, the present devices are capable of removing foreign substances from a USB port through simple manipulation, thus making it easy to insert a USB device into the USB port and preventing the malfunction of the USB device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for removing foreign substances from a USB port for vehicles, comprising:
a removal plate installed to a lower end in the USB port in such a way as to be able to move up and down;
a toothed rod mounted to the removal plate so as to be able to move the removal plate up and down, with teeth being provided on a surface of the toothed rod;
a gear assembly engaging with the teeth for moving the toothed rod up and down;
a reversible rotation motor for rotating the gear assembly in two opposite directions; and
a control unit for controlling operation of the motor.

2. The device as set forth in claim 1, wherein a signal indicating inflow of foreign substances is input from input unit of an audio device to the control unit.

3. The device as set forth in claim 1, wherein the toothed rod further comprises a guide unit to guide vertical movement of the toothed rod.

4. The device as set forth in claim 3, wherein the guide unit comprises:
a guide line for limiting the vertical movement of the toothed rod to a predetermined distance;
a guide screw installed at the guide line and being able to move with the toothed rod; and
a guide sensor installed at each of upper and lower ends of the guide line and transmitting a signal for stopping the motor to the control unit when the guide sensor comes into contact with the guide screw.

5. The device as set forth in claim 1, wherein the gear assembly comprises:
a first gear being rotatable by rotating force transmitted from the motor; and
a second gear engaging with the first gear and being rotatable along with the first gear, thus moving the toothed rod up and down.

6. The device as set forth in claim 1, wherein the control unit moves the removal plate downwards so that the removal plate automatically returns to an original position thereof in a predetermined time after the foreign substances are removed from the USB port.
